(19) United States
(12) Patent Application Publication
(10) Pub. No.: US 2026/0200707 A1
(43) Pub. Date: Jul. 16, 2026

(54) SYSTEM FOR HOOK SPEED CONTROL OF PIPELAYERS

(71) Applicant: Caterpillar Inc., Peoria, IL (US)

(72) Inventor: Curtis John Caldwell, Metamora, IL (US)

(73) Assignee: Caterpillar Inc., Peoria, IL (US)

(21) Appl. No.: 18/986,479

(22) Filed: Dec. 18, 2024

(51) Int. Cl. B66D 1/52; B66C 13/22; B66D 1/48; F16L 1/024

(52) U.S. Cl. CPC B66D 1/52; B66C 13/22; B66D 1/485; F16L 1/024; B66D 2700/0125

(57) ABSTRACT

A system for measuring load, from a cable, associated with a lifting hook of a lifting system such as a pipelayer is described. The system includes a load cell to detect load data describing a load on the hook and a controller configured to control a maximum hook lowering speed based on the load on the hook. The controller may determine the maximum speed by using sensor data such as temperature data as well as configuration data describing the makeup of the machine and machine components such as the types of bearings, configurations of blocks and pulleys, lubricant, and other such machine configurations to select a speed curve from a predetermined set of speed curves. The controller enables the hook to lower up to the maximum speed based on the speed curve and may also enable adjustment based on a gain setting to scale the maximum speed setting.

### TECHNICAL FIELD

The present disclosure relates to pipelayers having booms for performing load lifting and lowering operations. More particularly, the present disclosure relates to a system for monitoring and controlling the drop speed of a winch system.

### BACKGROUND

Pipelayers are generally used to suspend and place loads, such as pipelines, at an installation site or the like. A pipelayer typically includes a boom for handling such loads. In addition, the pipelayer includes a boom hoisting assembly for controlling a position of the boom during the installation of loads. During the installation, the pipelayer may be subjected to forces based on a weight of a load sustained by the boom and a position of the load relative to the pipelayer. It is desirable to accurately measure such forces for effective installation of loads. During installation, the winch drum may outrun the speed of the hook block when the hook on the pipelayer is lowered with no or minimal load, such as when a load is dropped in a rapid manner to prevent potential tipping of the pipelayer. When the hook is lowered and touches the ground, and the lowering command is still given then the winch drum may continue to rotate and cause the winch cable to tangle.

Chinese Patent No. 103523689 (hereinafter the “'689 Patent”) describes a petroleum drilling winch system and control method for the system. The '689 Patent describes a drilling winch system that includes a controller, an electromagnetic turbine brake, a disk type brake, a drum shaft assembly, and a double gear gearbox. The double gear gearbox is connected with alternating current frequency conversion motors through a clutch and connected with the drum shaft assembly through a clutch, the drum shaft assembly is connected with the electromagnetic turbine brake through a spline, and the disk type brake is connected between the drum shaft assembly and the electromagnetic turbine brake through the spline. The control system compares the speed of the winch hook to a set speed and uses the electromagnetic eddy current brake to control the winch hook within the winch hook set speed. The system provides for resolving the issue of bird nesting in reference to stopping the lowering of the load in a drill string in the petroleum industry. Such systems provide for rapid dropping of the load over long distances and then bringing the load to a stop after reaching a target depth.

The '689 Patent does not solve for situations where the load of a winch hook is dropped, for example to rapidly drop a load supported by a boom that may be causing a shift in the center of gravity of a pipelayer to prevent tipping of the pipelayer. However, when a hook is lowered, the winch drum can outrun the speed of the hook block when the hook on the pipelayer is lowered with no or minimal load, or when the winch is released, when the hook touches the ground, the drum may continue to spin and cause a bird's nest of the winch cable.

### SUMMARY OF THE INVENTION

In one aspect, the disclosure relates to a system for monitoring and controlling a load on a cable associated with a pipelayer. The system includes a load measurement component coupled between a boom block, engaged with the cable, and a portion of the pipelayer and configured to measure the load on the cable, a winch drum connected to the cable, a drive and brake system configured to control rotation of the winch drum, and a controller configured to control the drive and brake system, wherein the controller is configured to receive load data from the load measurement component and control a maximum speed of the winch drum in response to the load data based on a speed curve.

In some examples, the techniques the system further includes a temperature sensor, wherein the controller is configured to control the drive and brake system based at least in part on temperature data from the temperature sensor. The controller may be further configured to control the drive and brake system based at least in part on system configuration settings describing components of the pipelayer. The controller being configured to control the drive and brake system may include selecting the speed curve from a plurality of speed curves based on the temperature data and the system configuration settings. The plurality of speed curves may describe the maximum speed as a function of load measurement on a hook of the pipelayer. The controller may include a gain setting configurable by a user input, the gain setting configured to clip or set a maximum speed for a load on the speed curve based on the user input. The controller may be further configured to override the maximum speed in response to a user input.

In some aspects, the techniques described herein relate to a pipelayer including a main frame, a boom configured to pivot with respect to the main frame to allow lifting and lowering of the boom, the boom defining a first end coupled to the main frame and a second end away from the main frame, a cable engaged with the second end of the boom and a hook, the cable extendable by a winch coupled to the main frame, a load cell configured to measure a load on the cable, and a controller configured to control a maximum speed of the winch based on the load as determined based on data from the load cell and a speed curve.

In some aspects, the techniques described herein relate to a method for controlling a winch of a pipelayer, including receiving, at a controller of the pipelayer, temperature data associated with a temperature of the winch of the pipelayer, determining, by the controller and based on the temperature data, a speed curve describing an association between a load on a hook of the pipelayer and a maximum winch speed, determining, by the controller and based on load data describing a load on the hook, determining, based on the speed curve and the load data, a maximum speed for the winch, receiving a user input associated with a command for raising or lowering the hook, and controlling the winch based on the user input and the maximum speed for the winch.

### BRIEF DESCRIPTION OF THE DRAWINGS

FIG. 1 is a front view of an exemplary pipelayer having a boom and a cable associated with the boom, in accordance with at least one example.

FIG. 2 is a system architecture of a winch system for a pipelayer with adaptable winch speed control, in accordance with at least one example.

FIG. 3 is a lifting system and winch with a load management controller configured to control an adaptable maximum hook speed of the lifting system, in accordance with at least one example.

FIG. 4 is a block diagram of an architecture for a controller of a lifting system, in accordance with at least one example.

FIG. 5 is a block diagram of a control system for a machine, in accordance with at least one example.

### DETAILED DESCRIPTION

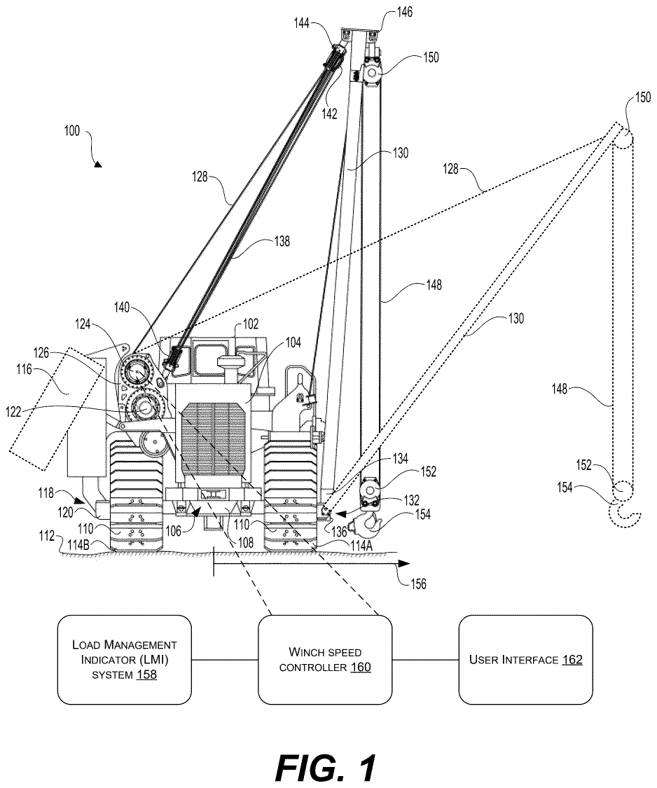

Referring to FIG. 1, a machine 100 is shown. In the illustrated embodiment, the machine 100 is embodied as a pipelayer used to perform pipelaying operations. The pipelaying operations may include but not limited to lifting and/or lowering of a load, such as a conduit segment, a pipe segment, a culvert segment, a drainage segment, and the like, and installing the load at an installation site, such as a trench. In an exemplary pipelaying operation, a pipe segment (to be installed in a trench) is lifted off of the ground by the machine 100, placed over top of the trench, and lowered into the trench by the machine 100.

During the pipelaying operation, a hook and winch mechanism of the machine 100 is used to raise and lower the segments of pipe. During such operations the winch drum may, in some instances, outrun the speed the hook block when the hook on the machine 100 is lowered. When the hook is lowered and touches the ground surface, and the lowering command is still given through a user input then the winch cable may bird nest.

The description provided herein enables hook speed control to prevent winch bird nesting during operation of the machine 100. A machine load management indicator (LMI 158) system is used to limit the winch speed during a lowering command which depends on the hook load (e.g., load amount on the hook) and ambient temperature (among other configuration settings) to prevent the winch drum from overrunning the hook block speed. The LMI 158 is a tunable machine software feature to accommodate different block masses/sizes along with if it has sleeve bearings, bushings, or ball bearings and to accommodate different types and temperatures of lubricants used within the blocks. The feature can be enabled or disabled and may also be adjusted with a gain setting to tune the speed setting as a function of the load on the hook based on a user input to the gain. The gain from the machine display allows an operator to adjust the sensitivity to account for different experience level, greases/oils, and/or ambient temperatures that effects lubricate viscosity that are used to lubricate the block. Further, if the winch is equipped with a quick drop feature the intelligent winch reel out feature may be overridden to enable the quick drop to prevent tipping of the machine 100.

Although references to the machine 100 are used, aspects of the present disclosure may also be applicable to other work machines equipped with booms, lifting systems, and winching systems for suspending loads, such as dragline excavators, rope shovels, cranes, etc., and references to the machine 100 in the present disclosure is to be viewed as purely exemplary.

The machine 100 includes an operator cabin 102, a propulsion system 104, a main frame 106, a forward end 108, and traction devices 110 for riding on a ground surface 112. The traction devices 110 include a first track 114A and a second track 114B.

The machine 100 includes a boom assembly 130, a boom hoisting assembly 128, and a counterweight assembly 116. The main frame 106 supports one or more components/assemblies of the machine 100, such as the propulsion system 104, the operator cabin 102, the boom assembly 130, the boom hoisting assembly 128, and the counterweight assembly 116, although other known components and structures may be supported by the main frame 106, as well. The main frame 106 may define a forward end 108 and a rearward end (not shown) opposite to the forward end 108. The forward end 108 and the rearward end may be defined in relation to an exemplary direction of travel of the machine 100, with said direction of travel being defined from the rearward end towards the forward end 108.

Also, the main frame 106 may define two lateral sides, namely, a first lateral side 132 and a second lateral side 118 opposite to the first lateral side 132. The two lateral sides (first lateral side 132 and second lateral side 118) may be located transversely relative to the exemplary direction of travel of the machine 100. In addition, the main frame 106 may include a first track roller frame 136 and a second track roller frame 120. The first track roller frame 136 may be disposed at the first lateral side 132 of the machine 100 and, the second track roller frame 120 may be disposed at the second lateral side 118 of the machine 100.

The traction devices 110 may support the main frame 106 (and thus the machine 100) over ground surface 112 and may be powered by the propulsion system 104 so as to facilitate movement of the machine 100 over an expanse of the installation site. The traction devices 110 may include tracks, or wheels, or a combination thereof. As shown in FIG. 1, the machine 100 includes two of the traction devices 110, namely, a first track 114A and a second track 114B. The first track 114A may be coupled to a first track roller frame 136 and, the second track 114B may be coupled to a second track roller frame 120. In other embodiments, it may be contemplated that higher or lesser number of tracks may be used in the machine 100.

The propulsion system 104 may include a power compartment and a power source (not shown) provided within the power compartment. The power source may include a combustion engine, or an electrical power source, or a combination thereof. The power source may be configured to generate an output power required to operate various systems or assemblies on the machine 100, with one operation exemplarily involving a pivoting of the boom assembly 130 with respect to the main frame 106 to lift or lower loads.

The operator cabin 102 may be supported over the main frame 106. The operator cabin 102 may facilitate stationing of one or more operators therein, to monitor and control the operations of the machine 100. Also, the operator cabin 102 may house various components and controls of the machine 100, access to one or more of which may help the operators to perform the pipelaying operations. For example, the various components and controls of the machine 100 may include, but not limited to, joysticks, switches, and the likes, to facilitate an operator in performing the pipelaying operations.

The boom assembly 130 may be disposed on the first lateral side 132 of the main frame 106. The boom assembly 130 is configured to lift and lower a load (e.g., pipe segment). The boom assembly 130 includes a boom, a first hook block 150, a second hook block 152, and a hook 154. The boom assembly 130 defines a first end 134 and a second end 146 opposite to the first end 134. The first end 134 of the boom assembly 130 is coupled to the main frame 106. For example, the first end 134 of the boom assembly 130 may be pivotally coupled to the first track roller frame 136, using one or more hinge pins. The second end 146 of the boom assembly 130 is defined away from the main frame 106.

Further, the boom assembly 130 may be formed of one or more leg segments. In the present embodiment, as shown in FIG. 1, the boom assembly 130 may include two or more leg segments. The leg segments extend between the first end 134 and the second end 146 of the boom assembly 130. For instance, the two leg segments may be pivotally coupled to the first track roller frame 136 at the first end 134 of the boom assembly 130 (via the hinge pins) and, are coupled to one another at the second end 146 the boom assembly 130. In this illustrated configuration, the leg segments impart a substantially elongated and triangular configuration to the boom assembly 130. In other embodiments, the boom assembly 130 may include single or multiple leg segments, based on application requirements.

The boom assembly 130 is configured to pivot with respect to the main frame 106. The boom assembly 130 may be pivotable between a raised position (as shown in FIG. 1) and a lowered position (shown in dashed lines) with respect to the main frame 106. In an example, the raised position of the boom assembly 130 may be a substantially vertical or stowed position of the boom assembly 130 that may facilitate tramming of the machine 100 across the site, whereas the lowered position of the boom assembly 130 may be a substantially horizontal position of the boom assembly 130 that may facilitate reach in order to suspend the load over a trench.

The first hook block 150 may be pivotally coupled to the second end 146 of the boom assembly 130. The second hook block 152 may be operably coupled to the first hook block 150 using a cable 148. The cable 148 may be actuated using a hook winch 122 supported on the main frame 106. Further, the hook 154 may be coupled to the second hook block 152. The hook 154 may be configured to suspend the load, such as a pipe section, to be lifted (or lowered). During a pipelaying operation, the cable 148 may be actuated by the hook winch 122 to raise or lower the second hook block 152 and the hook 154 relative to the ground surface 112.

The boom hoisting assembly 128 is now discussed. The boom hoisting assembly 128 may operate in a manner to move (e.g., pivot) the boom assembly 130 with respect to the main frame 106. For example, the boom hoisting assembly 128 facilitates pivoting of the boom assembly 130 between the raised position and the lowered position with respect to the main frame 106. The boom hoisting assembly 128 includes a boom winch 124, a first boom block 142, a second boom block 140, and a boom cable 138.

The boom winch 124 may include a frame 126 and a drum disposed at least partially within the frame 126. The frame 126 may be disposed towards the second lateral side 118 of the main frame 106. The frame 126 may define a pair of coaxial mounting bores. The drum may be configured to operate in a manner to actuate the boom cable 138. For example, the drum may be powered (e.g., via the power source) to rotate in one direction for winding the boom cable 138 thereon and, rotate in the other opposite direction for unwinding the boom cable 138 therefrom. The winding or unwinding of the boom cable 138 around the drum may result in pivoting of the boom assembly 130 between the raised position and the lowered position with respect to the main frame 106.

The first boom block 142 may include a housing and one or more first pulleys coupled to the housing. The first pulleys may be configured to receive and guide the boom cable 138 between the boom winch 124 and the second boom block 140. The first boom block 142 is coupled to the second end 146 of the boom assembly 130. For example, the housing of the first boom block 142 defines a first mounting portion to facilitate pivotal coupling between the first boom block 142 and the second end 146 of the boom assembly 130.

The second boom block 140 may be supported on the main frame 106. The second boom block 140 may include a housing and a pair of second pulleys coupled to the housing. The second pulleys may receive the boom cable 138 from the first boom block 142 and guide the boom cable 138 back to the first boom block 142 (or the boom winch 124) to operably couple the second boom block 140 with the first boom block 142 and the boom winch 124.

In this illustrated configuration, the boom cable 138 may run back and forth between the first pulleys of the first boom block 142 and the second pulleys of the second boom block 140, four times. However, it should be noted that the boom cable 138 may run fewer or more times depending on the number of first and second pulleys. This engagement between the boom winch 124, the first boom block 142, and the second boom block 140, (formed via the boom cable 138 extending therebetween) may aid the boom winch 124 in pivoting the boom assembly 130 with respect to the main frame 106.

During the pipelaying operation, the boom assembly 130 may be subjected to various forces (or moments), for example, due to weight and position of the load suspended from the hook 154. Such forces (or moments), if unaccounted for, may affect the stability of the machine 100, and in worst scenarios, may result in tipping of the machine 100. Therefore, determination of such forces (or moments) is necessary to avoid dangerous tipping situations and hence, to enhance the stability of the machine 100. To determine the forces (or moments) applied to the boom assembly 130 due to the suspended load, load (e.g., tension) from the boom cable 138 is to be measured. In the example depicted in FIG. 1, the load may be determined by using a load cell 144 connected between the first boom block 142 and the second end of the boom assembly 130. The load value determined based on data from the load cell may be used to determine the weight on the hook 154.

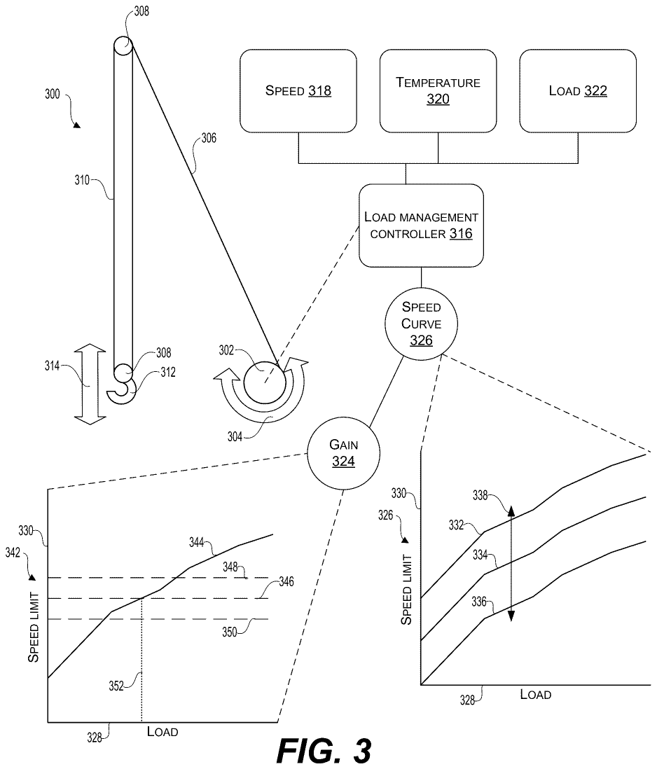

The LMI 158 may receive the load data from the load cell 144 and also receive sensor data and configuration data for the machine. A winch speed controller 160, described in further detail with respect to FIGS. 3-5 herein, provides control for a clutch and brake system of the winch, specifically the winch drum and provides for control of the speed of rotation of the winch drum based at least in part on the load data from the load cell 144 as well as additional data including configuration data and other sensor data.

The winch speed controller 160 is configured to control the drive, clutch, and brake system of a winch drum, wherein the controller is configured to receive load data from the load measurement component and controls a maximum speed of the winch drum in response to the load data based on a speed curve. The winch speed controller 160 may receive configuration data such as the number of legs of cable, number of pulleys, bearing or bushing type, grease type, and other such machine configuration data through the user interface 162. The winch speed controller 160 may also receive sensor data associated with the load cell 144, temperature data from a temperature sensor (e.g., an ambient temperature and/or a temperature of the grease, winch, or pulleys of the lifting system). The winch speed controller 160 may determine the speed curve by selecting a predetermined speed curve relating the maximum speed of the winch drum and/or hook speed as a function of load measurement on the hook. The speed curve may be pre-generated based on load and speed data associated with winch or lifting systems and information related to whether the speed conditions may be associated with a condition conducive to a bird nest. A plurality of speed curves may be generated that are associated with different temperatures, machine configurations, and other settings. Accordingly, the winch speed controller 160 may determine the one or more settings and select an appropriate speed curve based on the settings.

The controller may include a gain setting configurable by a user input through the user interface 162, the gain setting configured to clip or adjust a maximum speed for a speed curve based on the user input, for example to set a lower maximum speed for a particular load. The winch speed controller 160 may be further configured to override the maximum speed in response to a user input, for example to prevent instability of the machine 100.

The counterweight assembly 116 pivots to counter the movement of the boom assembly 130 to maintain machine stability as the boom is extended (as shown in dashed lines). With the boom extended (e.g., extended along direction 156), if the load on the hook 154 causes instability of the machine 100, the operator may select a user input such as a button or plunger to rapidly release the hook to lower under the force of gravity with the brake and clutch assembly disabled.

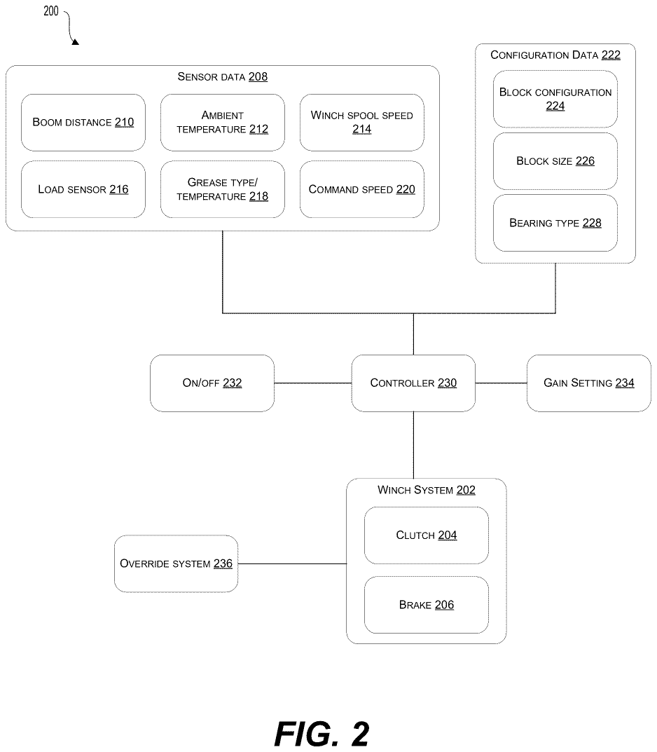

FIG. 2 is a system architecture of a lifting system 200 including a winch system 202 for a pipelayer with adaptable winch speed control, in accordance with at least one example. The pipelayer may be an example of the machine 100 of FIG. 1. The winch system 202 includes at least a clutch 204 and a brake 206 for controlling rotation of the winch drum. The winch system 202 is controlled by the controller 230 that may set a maximum speed for rotation of a winch drum of the winch system 202 during lowering of the hook to prevent bird nesting of the cable for the winch during lowering of the hook, particularly when the hook is loaded with a load amount below a threshold amount.

The controller 230 may provide a dynamic maximum speed setting for the winch system 202 based on a speed curve, such as described above and as shown and described with respect to FIG. 3. The controller 230 may receive inputs of sensor data 208 and configuration data 222 as well as an implementation of the controller via an activation signal 232. The controller 230 may therefore select a speed curve that is customizable and/or configured for implementation based on the current conditions in the environment of the machine 100 as well as the setup of the machine 100.

The sensor data 208 includes data related to the boom distance 210, ambient temperature 212, winch spool speed 214, load sensor 216, grease type/temperature 218, and command speed 220. The boom distance 210 may include data describing an angle and/or position of the boom assembly 130 such as from position sensors at the hinge connecting the boom assembly 130 to the main frame 106. The boom distance 210 may include information related to the horizontal position of the end of the boom assembly 130. The ambient temperature 212 may include information related to the temperature in the environment surrounding the machine 100. The ambient temperature 212 may include temperature data over time such as temperature trend information. The winch spool speed 214 may include speed data describing the rotation speed of the drum of the winch, such as from a rotary encoder or other such sensor configured to measure the speed of rotation of the drum. The load sensor 216 may include the load cell 144 of the machine 100 or other such sensors configured to detect a load on the hook 154. The grease type/temperature 218 may include an indication of a type of grease or lubrication used within the lifting system 200 such as a grease type and also includes a temperature of the lubricant (e.g., grease). The temperature may include temperature data over time, a temperature trend (e.g., increasing or decreasing over time) and other such information. The command speed 220 may include data related to the inputs received from an operator including a speed commanded for changing the height of the hook 154. The command speed 220 may also include information related to a direction for the command of the hook 154 such as against or in the direction of gravity.

The configuration data 222 may include data describing the configuration of the machine 100 that may not be associated with sensor data but may be input or provided through a user interface or other input device. The configuration data 222 includes block configuration 224, block size 226, bearing type 228, and other such information. The block configuration 224 may include information related to the configuration of the first block, second block, or other blocks of the machine 100 such as a size of shape of the block, a number of pulleys, and other such information. The block size 226 may include information related to the number of parts of cable (e.g., the number of lengths of line between the pulleys and/or the number of pulleys). The bearing type 228 may describe the bearing and/or lubrication type included within the lifting system such as a bearing, bushing, grease, or other such lubricant.

The sensor data 208 and the configuration data 222 may be used by the controller 230 to select a speed curve for controlling the winch system 202. The speed curve may be selected and/or scaled as described with respect to FIG. 3. The controller 230 may be enabled and based on the configuration data 222 and the present data from the sensor data, the speed curve may be selected to provide a maximum speed for the hook as a function of the load on the hook. The controller 230 may also receive inputs from the user and determine a gain setting 234 that may relate to a sensitivity of the controller 230. The gain setting 234 may be used to adjust the maximum speed of the hook as controlled by the controller 230. The gain setting may be manipulated based on the user input to adjust a maximum speed for the speed curve as a function of the load on the hook, for example by increasing the gain setting the maximum speed may be increased and by decreasing the gain setting the maximum speed may be decreased for a particular load on the hook.

The winch system 202 may have an override system 236 that may be enabled to override the controller 230 as well as the clutch 204 and the brake 206 to drop the hook 154 to the ground surface 112 regardless of the maximum speed dictated by the speed curve. The override system 236 may be used to prevent instability of the machine 100 in an instance where the boom assembly 130 is extended from the side of the machine 100 and may begin to tip based on the boom position and load on the hook 154. In an example, the boom distance 210 and load data from the load sensor 216 may be used to evaluate a potential instability of the machine 100 and enable the override system. In examples, the machine 100 may automatically engage the override system 236 in response to the boom distance 210 and the load sensor 216 and/or other data relating to the rotational position of the machine 100 relative to the ground surface 112 and/or gravity.

FIG. 3 is a lifting system 300 and winch with a load management controller 316 configured to control an adaptable maximum hook speed of the lifting system 300, in accordance with at least one example. The lifting system 300 is simplified in FIG. 3 to represent potential lifting systems of a pipelayer, crane, or other such machine that uses a cable 306 and a winch 302 including a winch drum for spooling the cable to raise and lower a hook 312. As depicted, the lifting system 300 includes blocks 308 with lengths of cable 310 for providing mechanical advantage for lifting of items using the hook 312 by including lengths of cable between cables disposed in the blocks 308. The lifting system 300 operates by rotating the winch 302 in a direction 304 to spool or unspool the cable 306 and thereby raise or lower the hook 312 along direction 314. During a lowering operation (e.g., in a direction parallel with an in the same direction as gravity), if the hook 312 is lowered at a rate that is too rapid, the winch 302 may overrun and cause bird nesting of the cable 306 as the winch 302 over-rotates, for example when the hook 312 reaches a ground surface that creates slack in the cable 306. To prevent such bird nesting, a load management controller 316 is implemented to set a dynamic maximum speed for lowering the hook 312. In some examples, the maximum speed may be for raising and lowering the hook 312.

The load management controller 316 receives data such as speed data 318 describing a speed of the cable 306 being let out. The speed data 318 may be determined from a sensor of a fairlead and/or based on the rotation rate of the winch drum, or some other speed data. The speed data 318 may also include the speed requested as a result of an operator input, such as by depressing a joystick or other user interface element. The load management controller 316 also receives temperature data 320 and load data 322. The temperature data 320 may be associated with a temperature of one or more components of the lifting system 300 such as the winch 302, blocks 308, or other such components. The temperature data 320 may also include ambient temperature data in the environment surrounding the lifting system 300. The load data 322 may include load data associated with a load disposed on the hook 312 and may be detected by a load cell connected to one of the blocks 308 or another component of the lifting system 300 configured to isolate and determine a load on the hook 312.

The load management controller 316 uses a speed curve 326 that may be selected based on operating criteria including the configuration of the lifting system 300 such as the particular arrangement of components, types of components, as well as information such as the ambient temperature and/or temperature of the lifting system 300. The speed curve 326 may also be adjusted or clipped by using a gain 324 to determine the dynamic maximum speed of the hook 312, especially when lowering. The speed curve 326 depicts functions 332, 334, and 336 that represent different maximum speed 330 as a function of the load 328 on the hook 312. The functions 332, 334, and 336 are depicted as having a similar shape but may be different in some examples. The speed curve 326 includes a plurality of functions (though only three are depicted, additional functions are contemplated) based on different temperatures and system configurations for the lifting system 300. The combination of the configuration for the lifting system and the temperature data 320 may be used to select a function for the speed curve 326 that is used by the load management controller 316 to set the maximum hook travel speed as a function of the load data 322. The configuration may include information such as the cable diameter, cable material, number of pulleys, configuration of blocks, hook weight, lengths of cable, bushing or bearing types in the blocks, lubricant type in the blocks, and other such configuration parameters of the lifting system 300. By providing the load management controller with the configuration settings of the particular lifting system, the load management controller may select from predetermined speed curves.

The trend 338 between functions generally provide that functions higher on the depiction of the speed curve allow for higher maximum lowering speeds of the hook 312 than functions lower on the depiction, when controlling for load amount. For example, moving vertically along the trend 338 may allow for compensation of temperature differences or changes. In an illustrative example, function 336 may be used when the temperature associated with the lifting system 300 is lower than a temperature associated with the lifting system when the function 334 is selected. The lower maximum speed may account for changes in the viscosity of the grease in the block 308 or other such changes with respect to temperature that may contribute to conditions for bird nesting of winch cable.

The gain 324 may be used to adjust or clip the maximum speed of the hook at a load value and may be a setting that is configurable by a user. As depicted, the speed curve 342 illustrates adjustments made to a particular speed function 344 based on the gain 324 setting input by an operator. The function 344 represents different maximum speeds as a function of load on the hook 312. As depicted, the function 344 provides for a first maximum speed 346 at a load value 352 associated with a neutral or zero gain adjustment meaning that the function 344 dictates the maximum speed without any adjustment. The gain 324 may be used to clip and/or adjust the maximum speed, for example with a positive gain adjustment associated with a second maximum speed 348 for the load value 352 and a negative gain adjustment associated with a third maximum speed 350 for the load value 352. For instance, an experienced operator may use the gain 324 to adjust the maximum speed for the load values, allowing the experienced operator to move the hook at higher travel speeds. A less-experienced operator may use a gain 324 that clips or reduces the maximum speed downwards and reduces the maximum hook speed. In some examples, the gain 324 may be expressed as a percentage, for example to adjust the maximum speed as dictated by the function by a percentage dictated by the gain 324. In some examples the gain 324 may be expressed as a unitless value that is used to clip or increase the maximum speed by an absolute amount at any load value. Though depicted with respect to the speed curve 342 at a particular load value 352, the maximum speed settings would adjust vertically as the load value changes. As the load value increases then the first maximum speed 346 would shift upwards following the function 344. The second maximum speed 348 and the third maximum speed 350 similarly shift as the first maximum speed 346 when the load value changes. The same adjustment occurs when the load value decreases and the first maximum speed 346 decreases.

The functions 332, 334, and 336 may be generated through empirical testing, for example testing hook speeds against load amounts as the hook 312 is lowered and touches the ground to identify a threshold value for different load amounts at which bird nesting is less likely to occur, or a threshold at which bird nesting will not occur. In examples, the functions 332, 334, and 336 may also be generated using one or more machine learning approaches, for example after data is gathered as described above for particular configurations of lifting systems 300, a trained machine learning algorithm may output functions for additional configurations of lifting systems beyond those tested empirically.

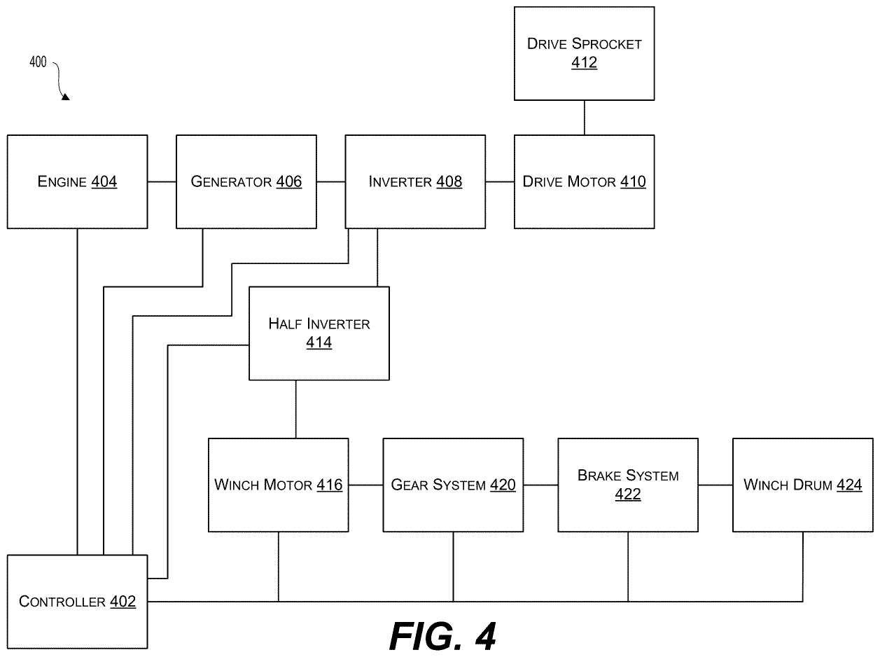

FIG. 4 is a block diagram of an architecture for a controller 402 of a lifting system 400, in accordance with at least one example. The lifting system 400 operates to reel in and reel out a cable, such as boom cable 138 or cable 148. The lifting system 400 is powered by a power source, such as engine 404 which may include an internal combustion engine, or any other suitable source of power. The lifting system 400, in embodiments, may include a generator 406 operatively connected to the engine 404 by a drive shaft, transmission, belt, chain, pump, or any suitable power transfer mechanism. The generator 406 converts power from the engine 404, such as torque when the power source rotates in operation, into electrical power such as AC current. An inverter 408 is electrically connected to the generator 406 and a drive motor 410 is electrically connected to the inverter 408. The drive motor 410 is configured to propel the machine 100 via one or more sprockets 412 (which may cooperate with ground engaging structure such as wheels or endless treads). The inverter 408 is configured to convert the AC power from the generator 406 into DC power.

The lifting system 400 may include a winch motor 416 that is electrically connected to the inverter 408. The winch motor 416 may have any desired configuration. In embodiments, the winch motor 416 may be a switched reluctance motor that operates with AC power. In operation, DC power may be supplied by the inverter 408 through an electrical cable or cable assembly to a second or half inverter 414 that converts the DC power to AC power. The AC power is then supplied through a cable assembly to drive the winch motor 416. In other embodiments, the inverter 408 may be configured to supply AC power to the winch motor 416 without the half inverter 414. In still other embodiments, the winch motor 416 may be a DC motor and DC power may be supplied by the inverter 408 or through another source on the machine without the half inverter 414. In yet other embodiments, the winch motor 416 is hydraulic or electrohydraulic. While an electrical system is given as an example of one means for operating the winches disclosed herein, it will be understood that hydraulically actuated winches are more typically employed in the operation of pipelayers, as well as other machines designed for use in construction and other settings.

A winch drum 424 of the winch may be operatively connected to the winch motor 416 by a gear system 420 that is operatively connected to the motor. In embodiments, the gear system 420 may be configured to provide a plurality of rotations of the winch motor 416 for each rotation of the winch drum 424. Rotation of the winch drum 424 may be arrested or prevented by a brake system 422 operatively connected thereto. The gear system 420 and the brake system 422 may have any desired configuration. In embodiments, the gear system 420 and the brake system 422 may be configured with a default condition in which rotation of the winch drum 424 is prevented (e.g., whereby the brake is applied) unless the brake system is disengaged. The winch drum 424 may be configured with the cable wrapped around it a plurality of times. The number of times that the cable is wrapped around the winch drum 424 is a function of the size of the drum as well as the length and diameter of the cable. Other configurations of the lifting system 400 are contemplated.

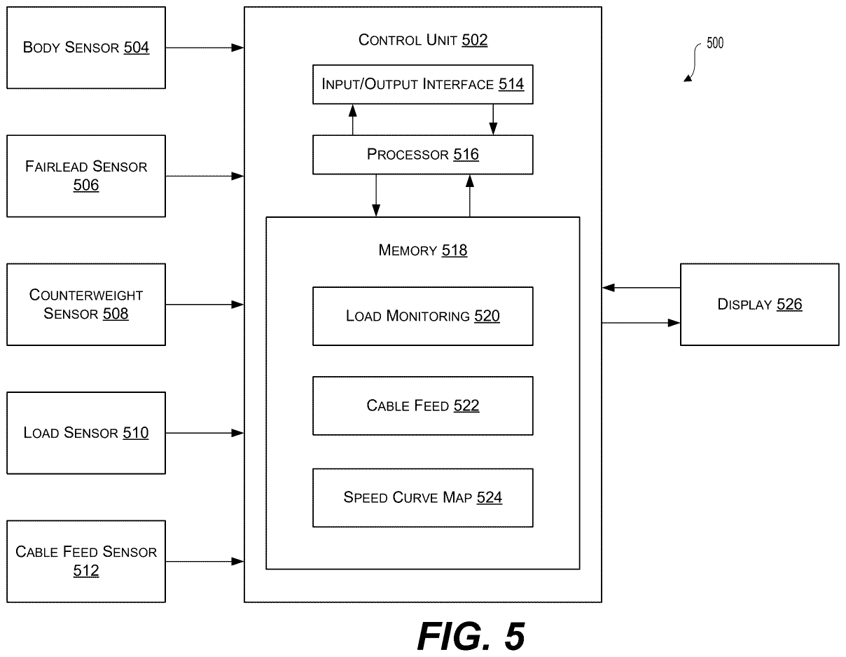

The operation of the engine 404, lifting system 400, and other systems and components of the machine 100 are controlled by a controller 402 as shown generally in FIG. 4. FIG. 5 shows one schematic example of a controller or control system. The controller 402 may receive input signals from an operator operating the machine 100 from within the cab or off-board the machine through a wireless communications system, for example.

The controller 402 may be any electronic controller that is configured to operate in a logical fashion to perform operations, execute control algorithms, store and retrieve data, and perform other desired operations. The controller 402 may include or may access memory, secondary storage devices, processors, and any other components for running at least one application. The memory and secondary storage devices may be in the form of read-only memory (ROM) or random-access memory (RAM) or integrated circuitry that is accessible by the controller. Various other circuits may be associated with the controller 402 such as power supply circuitry, signal conditioning circuitry, driver circuitry, and other types of circuitry.

The controller 402 may be a single controller or may include more than one controller disposed to control various functions and/or features of the machine 100. The term “controller” is meant to be used in its broadest sense to include one or more controllers and/or microprocessors that may be associated with the machine 10 and that may cooperate in controlling various functions and operations of the machine. The functionality of the controller 402 may be implemented in hardware and/or software without regard to the functionality. The controller 402 may rely on one or more data maps relating to the operating conditions and the operating environment of the machine that may be stored in the memory of controller. Each of these data maps may include a collection of data in the form of tables, graphs, and/or equations.

The controller 402 may be physically located on the machine 100 and may also include components located remotely from the machine. The functionality of controller 402 may be distributed so that certain functions are performed at machine 100 and other functions are performed remotely.

FIG. 5 is a block diagram of a control system 500 for a machine, in accordance with at least one example. Control system 500 also includes a control unit 502 having an input/output interface 514, for receiving inputs from various sensors and sending outputs in the nature of control commands, monitored quantities or qualities, and condition alerts as further discussed herein. Control unit 502 further includes a processor 516, which can include any suitable central processing unit such as a microcontroller or a microprocessor. Processor 516 is in communication with a memory 518 that stores computer executable program instructions in the nature of a load monitoring program 520 or control routine and a cable feed program 522 or control routine, as also further discussed herein. Memory 518 can include RAM, ROM, a hard drive, Flash, SDRAM, EEPROM, or still another type of memory. A speed curve map 524 is referenced by load monitoring program 520 to determine a load condition of machine 100, such as a maximum hook speed for dropping the hook relative to the load on the hook of the machine 100. A display 526, which may be mounted in or on operator station, can include a graphical user interface such as a touchscreen (not numbered), structured to convey various types of information to an operator, and receive control inputs from an operator. A plurality of icons may represent alerts or warnings that can be presented to an operator by way of illumination, for example. Other operator perceptible alerts such as audible alerts might be used.

The load monitoring program 520 may receive load data from one or more load cells of the machine 100 to determine a load on a hook of the machine. The cable feed program 522 may receive data from a cable feed sensor 512 to determine the amount of cable spooled out and/or a rate of cable feed. The speed curve map 524 may include a plurality of speed curves that describe a maximum speed for the control unit 502 to control the winch, brake, and/or clutch based on the load detected on the hook of the machine 100. In this manner, the control unit 502 may control the maximum speed to a lower maximum speed in response to the load on the hook being below a threshold and/or describe a mathematical relationship between the maximum speed and the load on the hook. The speed curve map 524 may include a plurality of different speed curves based on different configuration settings of the machine and/or other data such as temperature data, as described herein. Accordingly, the control system 500 may control the winch, clutch, and/or brake to prevent the cable from spooling out as the hook is lowered at a rate higher than the maximum speed dictated by the relationship on a particular speed curve.

A body sensor 504 produces a body monitoring signal for the frame of the machine 100 indicative of an orientation of the main frame relative to an underlying substrate. A fairlead sensor 506 structured to produce a fairlead monitoring signal indicative of an orientation of the boom and an associate fairlead. Control system 500 further includes a load sensor 510 structured to produce a load monitoring signal indicative of a load on hoisting cable and/or hook. In one embodiment each of fairlead sensor 506 and load sensor 510 is resident on boom assembly 130. Control system 500 also includes a cable feed sensor 512 structured to produce a cable feeding signal indicative of a length of hoisting cable fed through the fairlead and/or spooling off the winch drum. Cable feed sensor 512 may also be resident on a fairlead and/or the winch drum. A counterweight sensor 508 is associated with a counterweight of the machine and structured to produce a counterweight monitoring signal indicative of an orientation of the counterweight relative to frame of the machine 100. It should be appreciated that a position of any one of the pivotable components of interest discussed herein can be indicative of an orientation, and vice versa such that the terms position and orientation are used interchangeably. Accordingly, rotary potentiometers, linear potentiometers, Hall effect sensors, inductive sensors, capacitive sensors, mechanical switches, and still others can be employed to directly, indirectly, or inferentially indicate relative positions and orientations of components of the machine 100, the significance of which will be further apparent from the following description.

### INDUSTRIAL APPLICABILITY

During a pipelaying operation, the hook may be lowered to lower a pipe, load, or the hook itself and contact a ground surface. Upon contacting the ground surface, the momentum within the winch drum may cause the winch drum to continue to rotate and slack may be generated in the cable supporting the hook. The slack and continued rotation of the winch drum may result in bird nesting or tangling of the cable. Such tangling may cause the pipelayer to be inoperable until the cable is untangled, straightened, and potentially replaced. Therefore, prevention of bird nesting on the winches of a pipelayer or other lifting system prevents significant machine downtime and repair expense.

In this regard, the present disclosure provides a load management controller capable of receiving load data describing a load on a hook of the lifting system and using a pre-generated speed curve to set a maximum hook travel speed while lowering the hook to prevent or reduce instances of bird nesting.

The pipelaying operations may include but not limited to lifting and/or lowering of a load, such as a conduit segment, a pipe segment, a culvert segment, a drainage segment, and the like, and installing the load at an installation site, such as a trench. In an exemplary pipelaying operation, a pipe segment (to be installed in a trench) is lifted off of the ground by the machine 100, placed over top of the trench, and lowered into the trench by the machine 100.

During the pipelaying operation, a hook and winch mechanism of the machine 100 is used to raise and lower the segments of pipe into position on the ground and/or within the trench (e.g., on a bottom surface of the trench). During such operations the winch drum may, in some instances, outrun the speed of the hook block when the hook on the machine 100 is lowered and contacts the ground surface. When the hook is lowered and touches the ground surface, and the lowering command is still given through a user input then the winch cable may bird nest.

The description provided herein enables hook speed control to prevent winch bird nesting during operation of the machine 100. A machine load management indicator (LMI 158) system is used to limit the winch speed during a lowering command which depends on the hook load (e.g., load amount on the hook) and ambient temperature (among other configuration settings) to prevent the winch drum from overrunning the hook block speed. The LMI 158 is a tunable machine software feature to accommodate different block masses/sizes along with if it has sleeve bearings, bushings, or ball bearings and to accommodate different types and temperatures of lubricants used within the blocks. The feature can be enabled or disabled and may also be adjusted with a tunable gain setting based on a user input. The gain from the machine display allows an operator to adjust the sensitivity to account for different experience level, greases/oils, and/or ambient temperatures that effects lubricate viscosity that are used to lubricate the block. Further, if the winch is equipped with a quick drop feature the intelligent winch reel out feature may be overridden to enable the quick drop to prevent tipping of the machine 100.

Unless explicitly excluded, the use of the singular to describe a component, structure, or operation does not exclude the use of plural such components, structures, or operations or their equivalents. The use of the terms “a” and “an” and “the” and “at least one” or the term “one or more,” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B” or one or more of A and B”) is to be construed to mean one item selected from the listed items (A or B) or any combination of two or more of the listed items (A and B; A, A and B; A, B and B), unless otherwise indicated herein or clearly contradicted by context. Similarly, as used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

It will be apparent to those skilled in the art that various modifications and variations can be made to the system and/or the pipelayer of the present disclosure without departing from the scope of the disclosure. Other embodiments will be apparent to those skilled in the art from consideration of the specification and practice of the system and/or the pipelayer disclosed herein. It is intended that the specification and examples be considered as exemplary only, with a true scope of the disclosure being indicated by the following claims and their equivalent.

What is claimed is:

1. A system for monitoring and controlling a load on a cable associated with a pipelayer, the system comprising:
a load measurement component coupled between a boom block, engaged with the cable, and a portion of the pipelayer and configured to measure the load on the cable;
a winch drum connected to the cable;
a drive and brake system configured to control rotation of the winch drum; and
a controller configured to control the drive and brake system, wherein the controller is configured to receive load data from the load measurement component and control a maximum speed of the winch drum in response to the load data based on a speed curve.

2. The system of claim 1, further comprising a temperature sensor, wherein the controller is configured to control the drive and brake system based at least in part on temperature data from the temperature sensor.

3. The system of claim 2, wherein the controller is further configured to control the drive and brake system based at least in part on system configuration settings identifying components of the pipelayer.

4. The system of claim 3, wherein the controller being configured to control the drive and brake system comprises selecting the speed curve from a plurality of speed curves based on the temperature data and the system configuration settings.

5. The system of claim 4, wherein the plurality of speed curves indicate the maximum speed as a function of load on a hook of the pipelayer.

6. The system of claim 1, wherein the controller comprises a gain setting configurable by a user input, the gain setting configured to adjust a maximum speed based on the user input.

7. The system of claim 1, wherein the controller is further configured to override the maximum speed in response to a user input.

8. A pipelayer comprising:
a main frame;
a boom configured to pivot with respect to the main frame to allow lifting and lowering of the boom, the boom defining a first end coupled to the main frame and a second end away from the main frame;
a cable engaged with the second end of the boom and a hook, the cable extendable by a winch coupled to the main frame;
a load cell configured to measure a load on the cable; and
a controller configured to control a maximum speed of the winch based on the load as determined based on data from the load cell and a speed curve.

9. The pipelayer of claim 8, further comprising a temperature sensor, wherein the controller is configured to control the winch based at least in part on temperature data from the temperature sensor.

10. The pipelayer of claim 9, wherein the controller is further configured to control the winch based at least in part on system configuration settings describing components of the pipelayer comprising at least one of:
parts of line;
type of block;
grease type;
bearing type; and
other configurations of the cable and hook.

11. The pipelayer of claim 10, wherein the controller being configured to control the winch comprises selecting the speed curve from a plurality of speed curves based on the temperature data and the system configuration settings.

12. The pipelayer of claim 11, wherein the plurality of speed curves indicate the maximum speed of the hook or the winch as a function of load on the hook of the pipelayer.

13. The pipelayer of claim 8, wherein the controller comprises a gain setting configurable by a user input, the gain setting configured to adjust a maximum speed based on the user input.

14. The pipelayer of claim 8, wherein the controller is further configured to override the maximum speed in response to a user input.

15. A method for controlling a winch of a pipelayer, comprising:
receiving, at a controller of the pipelayer, temperature data associated with a temperature of the winch of the pipelayer;
determining, by the controller and based on the temperature data, a speed curve describing an association between a load on a hook of the pipelayer and a maximum winch speed;
determining, by the controller and based on data from a load sensor system, load data relating to a load on the hook;
determining, based on the speed curve and the load data, a maximum speed for the winch;
receiving a user input associated with a command for raising or lowering the hook; and
controlling the winch based on the user input and the maximum speed for the winch.

16. The method of claim 15, further comprising determining a gain input for the controller, the gain input configured to tune the speed curve to adjust the maximum speed.

17. The method of claim 15, further comprising determining one or more system configurations for the winch and a lifting system of the pipelayer, wherein the speed curve is further determined based on the one or more system configurations.

18. The method of claim 15, further comprising:
determining a ground contact of the load on the hook; and
controlling a drum of the winch to reduce the maximum speed of the winch and prevent tangling of a cable of the winch in response to the load on the hook reducing when the load is dropped.

19. The method of claim 15, wherein controlling the winch based on the user input is further in response to an input enabling maximum speed control of the winch.

20. The method of claim 15, further comprising overriding the maximum speed of the winch in response to machine instability.
